(19) United States
(12) Patent Application Publication
(10) Pub. No.: US 2019/0300673 A1
(43) Pub. Date: Oct. 3, 2019

(54) BIO-BASED POLYMER COMPOSITIONS

(71) Applicant: KLAUS DAHLEKE KG, HAMBURG (DE)

(72) Inventor: CRISTINA BERGMANN, HAMBURG (DE)

(21) Appl. No.: 16/340,392

(22) PCT Filed: Oct. 5, 2017
(86) PCT No.: PCT/EP2017/075369

§ 371 Date: Apr. 11, 2019

(30) Foreign Application Priority Data
Oct. 11, 2016 (EP) 16193272.8

(51) Int. Cl. C08K 5/11; C08K 5/01; C08L 9/06; C08L 23/16; C08K 5/09

(52) U.S. Cl. CPC C08K 5/11; C08K 5/01; C08K 5/09; C08L 23/16; C08L 9/06

(57) ABSTRACT

The invention relates to a polymer composition for technical plastic products, containing a thermoplastic elastomer or a rubber, or a bioplastic, and a plasticizer. The invention also relates to the use of the polymer composition for technical plastic goods. The polymer compositions do not contain any fossil raw material-based plasticizers. Nevertheless, polymers can unexpectedly be obtained which demonstrate good mechanical, physical and improved VOC and FOG properties for technical plastic goods such as technical rubber articles.

The invention has as subject matter a polymer composition for technical plastic products containing a thermoplastic elastomer, a rubber or a bioplastic and a plasticizer, as well as the use of the polymer composition for technical plastic goods.

Bioplastics are becoming increasingly significant on account of an increased awareness of the environment and an expected shortage of the supply of fossil sources such as petroleum and natural gas. One of the most frequently used bioplastics are polylactides (PLA). They are used in particular for packaging food, in agriculture and in the hygiene area since in these areas the bioplastics frequently serve for a one-time use and the service life of the products is usually short. There is also comprehensive research regarding being able to use bioplastics even in areas in which a multiple usage and a longer service life are desired. In particular, a usage for technical areas or consumer products is desirable. Polylactides are usually based on corn or sugarcane. There are various papers concerning improving the mechanical properties of PLAs. M. C. Coskun et al. Rubberworld.com, October 2015, pp. 44-46 describe, for example, the addition of additives to improve the flexibility and the impact resistance.

Thermoplastic elastomers are a technically increasingly important group of polymers. They have properties of elastomers as well as of thermoplastics and comprise soft, elastic blocks and hard, crystallizable blocks. Thermoplastic elastomers are used in various applications such as, e.g. in the automobile area, for consumer products, packages, for medical products and in the construction area. There already exists thermoplastic elastomers which can be biologically degraded and are therefore a bioplastic.

WO 2009/112438 A1 teaches biologically degradable elastomers which have a hardness (Shore A) between 50 and 65. The elastomers contain a thermoplastic polyester urethane segment and a copolyester segment based on a diol copolymer. The monomers stem from fossil sources.

The invention has as subject matter a polymer composition containing

a) thermoplastic elastomer, a rubber or a bioplastic and
b) a plasticizer,
characterized in that the plasticizer is a vegetable raw material or a raw material product based on an industrial plant or on the basis of an animal fat source and preferably contains no plasticizers based on fossil raw materials in the polymer composition.

Other embodiments are described in the following.

Thermoplastic elastomers (TPE) in the sense of the invention are polymers which comprise a combination of the wearing properties of elastomers and the processing properties of thermoplastics. The polymers simultaneously comprise soft, elastic blocks with high expandability and a low glass transition temperature (Tg) and hard, crystallizable blocks with low expandability. Both blocks are incompatible with one another so that a microphase separation results since the blocks are separately present (Rompp, online Georg Thieme Verlag KG, Stuttgart 2008, keyword thermoplastic elastomer).

Suitable TPEs in the sense of the invention are, for example:
TPE-O thermoplastic elastomers on an olefin basis
TPE-S styrene block copolymers such as, e.g., SBS, SEBS, SIS, SBC
TP-NR thermoplastic natural rubber
TP-NBR thermoplastic nitrile rubber
TP-FKM thermoplastic fluorinated rubber
TP-Q thermoplastic silicone rubber
TPE-U thermoplastic polyurethanes
CPE-CPA copolymer polyether ester
TPE-A thermoplastic elastomers based on copolyamides
TPE-E are also designated as COPE or thermoplastic rubber.

The polymer composition according to the invention preferably contains a TPE-S in an embodiment. Suitable TPE-S's in the sense of the invention are, e.g., a block copolymer with the basic structure poly(styrene ethylene/butadiene-styrene) or poly (styrene-butadiene-styrene). The latter are also designated as S-E-B-S or S-B-S. The polystyrene block constitutes the hard part of the TPE here and the butadiene the soft, elastomeric part of the TPE.

The polymer composition according to the invention preferably contains an ethylene-propylene-diene rubber (EPDM) as rubber in another embodiment. EPDM is a rubber which is produced by the terpolymerization of ethene with larger amounts of propylene and a lesser amount of a third monomer with diene structure. The diene monomers used are preferably cis,cis-1,5-cyclooctadiene (COD), exo-dicyclopentadiene (DCP), endo-dicyclopentadiene (EDCP), 1,4-hexadiene (HX) and 5-ethylidene-2-norbornene (ENB). In this embodiment the polymer composition preferably contains an EPDM with 5-ethylidene-2-norbornene as diene monomer.

Bioplastics in the sense of the invention are based at least partially on renewable raw materials or can be biologically degraded or both. The designation refers here to the polymer skeleton itself and/or fillers and not to additives or plasticizers which are added to the plastic. The bioplastics are preferably based on renewable raw materials. The renewable raw materials preferably stem from the industrial plants described in the following or from the animal fat sources described in the following. The bioplastics are especially preferably thermoplastic elastomers.

The plasticizer in the polymer composition according to the invention is a vegetable raw material or a raw material product based on an industrial plant or on the basis of an animal fat source and no plasticizers based on fossil raw materials. A chemical distinction is made between organic and inorganic substances. Naturally, existing organic raw materials stem from living nature, i.e., they are either animal or vegetable substances. A vegetable raw material is an organic compound or a mixture of organic compounds obtained, e.g. extracted from a plant. A raw material product based on an industrial plant is also an organic compound or a mixture of organic compounds obtained from the plant by processing. The vegetable raw materials, which are frequently mixtures of different organic compounds, have special compositions and distributions of the organic compounds given by the plant. For example, vegetable oils or animal fat sources such as, e.g. butter, are cited here by way of example. The same applies to raw material products which also have a characteristic chemical composition given by the vegetable or animal source. Organic substances can also be artificially extracted from fossil sources such as, e.g., petroleum, carbon or natural gas. These organic substances from fossil sources are preferably not contained in the polymer composition according to the invention. Vegetable or animal raw materials such as, e.g., vegetable oils or sugarcane or rape products cannot be produced in the same chemical composition from fossil sources.

The industrial plant in the sense of the invention is preferably selected from the group consisting of trees, sunflower, rape, beets, corn, jojoba, peanut, coconut, thistle, castor oil, palm, hemp, poppy, olive, sugarcane, sugar beets and grain.

Animal fats in the sense of the invention are preferably selected from butter, lard, tallow, fat, herring, sardine.

The vegetable raw material extracted from these industrial plants is preferably a vegetable oil selected from lignin oil, sunflower oil, rape oil, beet oil, corn oil, hemp oil, olive oil, linseed oil, soybean oil, palm oil, jojoba oil or the raw material extracted from these industrial plants is a raw material product of starch, cellulose or lignin. A product from sugarcane or sugar beet or a palm oil product or a sunflower product or rape product is especially preferably used as plasticizer.

The plasticizer in the polymer composition according to the invention is especially preferably a vegetable raw material selected from the groups I to III with

I) group I fatty esters according to formula (I)
II) group II triglycerides according to formula (II) and
III) group III dimerates based on dimeric acids according to formula (III).

The plasticizers of group I are fatty acids esters according to the formula (1)

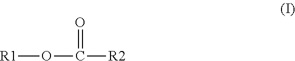

wherein
R1 is a substituted or unsubstituted aryl group with 1 to 22 carbon atoms, preferably 1 to 10 carbon atoms, especially preferably selected from the group consisting of substituted and unsubstituted phenyl groups or a substituted or unsubstituted, linear or branched alkyl group with 1 to 22 carbon atoms, or a substituted or unsubstituted, linear or branched alkene group with 1 to 22 carbon atoms and one, two or three double bonds, especially preferably one double bond, and
R2 is a substituted or unsubstituted linear or branched, saturated or unsaturated aliphatic hydrocarbon group with 1 to 3 carbon atoms, especially preferably a linear, unsaturated, aliphatic hydrocarbon group with 1 to 21 carbon atoms and one, two or three double bonds. R2 is especially preferably a linear, unsaturated, aliphatic hydrocarbon group with 1 to 17 carbon atoms and one double bond.

If R1 is an alkyl group, it is preferably selected from the group consisting of ethyl, propyl-, butyl-, pentyl-, hexyl-, heptyl-, octyl-, 2-ethyl-hexyl-, nonyl-, decyl-, stearyl-, oleyl- and especially preferably 2-ethyl-hexyl, decyl- or oleyl-. If R1 is an alkene group with a double bond, the double bond is preferably arranged at position 9.

The number of carbon atoms in the group refers, unless otherwise indicated, to the total number of all carbon atoms of the group including the carbon atoms of the substituents and side groups.

The fatty acid esters are preferably selected from the group of fatty acid alkyl esters and the fatty acid aryl ester according to formula (1)

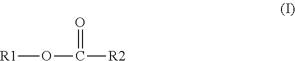

wherein
R1 is a substituted or unsubstituted, linear or branched alkyl group with 1 to 22 carbon atoms, preferably ethyl-, propyl-, butyl-, pentyl-, hexyl-, heptyl-, octyl-, 2-ethyl-hexyl, nonyl-, decyl-, stearyl- or oleyl- and especially preferably 2-ethyl-hexyl, oleyl- and decyl- and
R2 is a substituted or unsubstituted, linear or branched, saturated or unsaturated aliphatic hydrocarbon group with 1 to 21 carbon atoms, preferably a linear, saturated or unsaturated aliphatic hydrocarbon groups with 1 to 21 carbon atoms, especially preferably a linear, unsaturated aliphatic hydrocarbon group with 1 to 21 carbon atoms and one, two or three double bonds. R2 is especially preferably a linear, unsaturated aliphatic hydrocarbon group with 1 to 17 carbon atoms and one double bond.

The fatty acid ester is preferably selected from the group of the following esters:
alkyl arachidonate,
alkyl linoleate,
alkyl linolenate,
alkyl laurate,
alkyl myristate,
alkyl oleate,
alkyl caprate,
alkyl stearate,
alkyl palmitate,
alkyl caprylate,
alkyl caproate,
alkyl butanoate and
alkyl behenate.

The fatty acid alkyl ester 2-ethylhexyl oleate, 2-ethylhexyl stearate, decyl oleate, decyl stearate, oleyl oleate, oleyl stearate or a mixture of these fatty acids is especially preferred.

The plasticizers of group II are triglycerides according to formula (II)

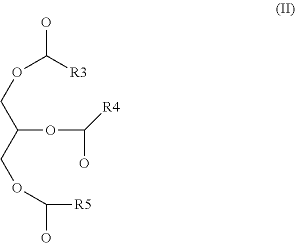

wherein R3, R4 and R5 are respectively a substituted or unsubstituted, linear or branched alkyl group with 1 to 22 carbon atoms or a substituted or unsubstituted, linear or branched alkene group with 1 to 22 carbon atoms and one, two or three double bonds, especially preferably with one double bond. Triglycerides are esters of glycerol in which all three hydroxy groups are esterified with fatty acids.

The groups R3, R4 and R5 are especially preferably identical, preferably an oleate group, preferably a group with 17 carbon atoms with the following structure:

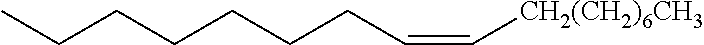

The plasticizers of the group III are dimerates in the form of a reaction product of a dimeric acid according to the formula (III) and of a straight-chain or branched alcohol which is saturated or unsaturated with 1 to 3 carbon-carbon double bonds and has 1 to 22 carbon atoms:

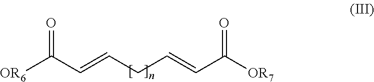

wherein n is preferably a whole number between 1 and 40, preferably 30, and R6 and R7 are independently of one another each a substituted or unsubstituted, linear or branched alkyl group with 1 to 22 carbon atoms, preferably methyl-, ethyl-, propyl-, butyl-, pentyl-, hexyl-, heptyl-, octyl-, 2-ethyl-hexyl, nonyl-, decyl-, stearyl- or oleyl-.

Dimerates are esters of unsaturated fatty acid dimers. The dimerized fatty acids are obtained by dimerizing the particular fatty acid. The esters are obtained by reacting the dimeric acids with alcohols. The alcohol is preferably methanol, 2-ethyl hexyl alcohol, tridecyl alcohol or oleyl alcohol.

According to the invention, even mixtures of different plasticizers of the groups (I), (II) and (III) or the mixtures of plasticizers from one of the three groups can be used.

The polymer composition according to the invention comprises in a preferred embodiment
a) a thermoplastic elastomer and
b) one or more plasticizers from one or more of the groups I to III.

The thermoplastic elastomer is preferably a TPE-S, i.e., a styrene block copolymer, preferably a styrene-butylene-styrene block polymer (SBS), styrene-butylene-styrene block copolymer (SBS), or a styrene-ethylene/butylene-styrene block polymer (SEBS).

The polymer composition according to the invention comprises in another preferred embodiment
a) an EPDM and
b) one or more plasticizers from one or more of the groups I to III.

The polymer composition according to the invention contains the plasticizer preferably at 1 to 250 parts by weight, preferably 5 to 100 parts by weight, doubly especially preferably 5 to 30 parts by weight relative to the total weight of the polymer composition.

The polymer composition according to the invention is distinguished especially by its mechanical and physical properties. Surprisingly, hard, impact-resistant polymers were able to be obtained although plant-based plasticizers were used as raw material. The polymer composition according to the invention has a hardness (Shore A) of 20 to 100, preferably 30 to 90, especially preferably 70 to 85 measured according to DIN EN ISO 868.

Surprisingly, the polymer compositions according to the invention have a distinctly longer strain at break and at the same time a distinctly higher ultimate stress. The strain at break of a TPE-S measured according to DIN 53504 is preferably in the range of >400%, especially preferably in the range between 450 and 700% and therefore distinctly above the strain at break of polymer compositions with plastics based on mineral oil. The ultimate stress of a TPE-S measured according to DIN 5504 is preferably >3.5 MPa, especially preferably between 4.00 and 5.00. Even the ultimate stress is accordingly better than in polymer compositions with mineral-oil-based plastics.

Plastics which are used in areas close to people, for example, in a household or an automobile should emit only a maximum content of volatile, organic compounds. The content of volatile, organic compounds, i.e. of all gaseous and vaporous substances with an organic origin in the air (i.e., Volatile Organic Compounds) is indicated by the VOC value. The VOC value according to VDA 278 is the sum of the low- to moderately volatile substances and is calculated as the toluene equivalent. Basically, the lowest possible VOC value is always desirable. As a supplement, the FOG value is measured. The FOG value is, according to VDA 278, the sum of the difficultly volatile substances which elute after and including the retention time of n-tetradecane. It is calculated as the hexadecane equivalent. There are boundary values for the VOC value and the FOG value which must be observed for many areas of application and in particular in automobile construction.

The polymer composition according to the invention preferably has a target of a VOC value <100 μg/g measured according to VDA 278. More preferably, the polymer composition according to the invention has a FOG value target of <250 μg/g measured according to VDA 278 with thermodesorption analysis (TDS). The calibration takes place with the reference substances toluene for the VOC value and n-hexadecane for the FOG value.

The polymer composition according to the invention is used for technical plastic items. The technical plastic item according to the invention is in one embodiment a technical rubber item. Technical rubber items are, e.g., seals, hoses, bumpers, sieve seals for pane washing systems, air suction hoses, folding bellows, bearing sleeves, lamp seals, connection plugs, hoses, muffs, membranes, pump diaphragms, shock absorber systems, damping elements.

In another embodiment the technical plastic item used according to the invention is a technical plastic product. Preferred technical plastic products are interior car parts, outer car parts, soft handles, sport devices and sport device parts, sport accessories, toys and toy parts, care articles for infants and small children, tools, tool parts and household items.

In one embodiment the polymer composition according to the invention additionally contains additives and/or pigments and/or fillers. Additives can be, e.g., cross-linking agents, accelerators, activators. Suitable fillers are, for example, natural organic substances such as, e.g., wood meal, wood fibers or cellulose, mineral fillers such as, e.g., ground chalk, ground limestone, ground marble, precipitated calcium carbonate, reinforcing fibers such as, e.g., glass fibers or glass filaments, carbon fibers, textile fibers or natural fibers. According to the invention, calcium carbonate or barium sulfate are preferably used as filler.

The invention is explained in detail using the following examples.

Different plasticizers were worked into a TPE-S. The formulations of the TPE-S produced are shown in table 1. All raw materials were used without further pretreatment.

TABLE 1
Formulations of the TPE compounds produced (parts by weight)

| Raw material | Reference | Ex- | Ex- | |
|---|---|---|---|---|
| (wt. %) | example A | ample 1 | ample 2 | Example 3 |
| SEBS | 16.61 | 16.61 | 16.61 | 16.61 |
| (Calprene ® H 6174 from the | | | | |
| Dynasol company) | | | | |
| Paraffin plasticizer based on | 14.95 | | | |
| mineral oil (Pionier M 1930 | | | | |
| from the Hansen & | | | | |
| Rosenthal KG company) | | | | |
| 2-ethylhexyl dimerate (Radia | | 14.95 | | |
| 7121 from the Oleon | | | | |
| company) | | | | |
| Alkenes C10-16 a-, mixed | | | 14.95 | |
| with (6E)-7,11-dimethyl-3- | | | | |
| methylene-1,6,10- | | | | |
| dodecatriene, tetramers and | | | | |
| trimers, hydrogenated | | | | |
| (Novaspec 2050 from the | | | | |
| NOVVI company) | | | | |
| Glycerol trioleate (palmester | | | | 14.95 |
| 4010 from the KLK Oleo | | | | |
| company) | | | | |
| Polypropylene homopolymer | 8.31 | 8.31 | 8.31 | 8.31 |
| (Borealis HD 120 MO from | | | | |
| the Borealis company) | | | | |
| Calcium carbonate | 59.80 | 59.80 | 59.80 | 59.80 |
| (Omyacarb 5 GU from the | | | | |
| Bassermann Minerals | | | | |
| company) | | | | |
| Antioxidants (Irganox B225 | 0.33 | 0.33 | 0.33 | 0.33 |
| of the BASF company) | | | | |

The compounding was carried out on a double worm extruder rotating in the same direction of the ZSE 18 HPe type of the Leistritz company. On the whole, pre-mixture compounds for 1.80 kg (including chalk) were produced for all formulations. To this end, all components with the exception of the chalk were premixed in a rapid mixture and supplied gravimetrically to the extruder via the main feeding apparatus. The calcium carbonate was added gravimetrically via a side loading. The exiting melted strands were cooled in a water bath and subsequently granulated.

A falling temperature profile between 180° C. and 170° C. was adjusted. The rotational speed was about 400 min-1 of the total throughput at 5 kg/h. A smooth compounding was possible for all compounds.

### Plate Pressing

Plates were pressed on a plate press P300 P/M of the Dr. Collin GmbH company at 190° C. with a preheating time of 10 min at a pressure of 100 bar. Directly after the pressing process the cooling process was initiated with a cooling-off rate 10 10 K/min to a temperature of 40° C. The plate was subsequently cooled in the closed tool another 14 min at 40° C. in order to avoid a deformation of the specimen body during the opening of the tool. A round immersion edge tool with an inside diameter of 220 mm was used as pressing tool. The thickness of the produced plates was ca. 2 mm. Plasticizer migration or adhering, greasy surfaces were not determined for any of the formulations.

The checking of the hardness (Shore A) according to DIN EN ISO 868 and the density of the samples according to DIN EN ISO 1183 then took place for the pressed plates. Furthermore, traction rods (S2) were stamped out of the plates and traction tests were carried out according to DIN 53504. The measuring of the VOC values and of the FOG values took place according to VDA 278 with toluene (VOC and n-hexadecane (FOG) as reference substance. Two samples were taken. In order to determine the VOC values, the specimen is heated 30 minutes at 90° C. In order to determine the FOG value, the second sample is heated 60 minutes at 120° C. The emitting substances are cryofocused in a cooling trap. The content of the cooling trap is subsequently heated to 280° C. and the evaporating substances analyzed with GC-MS. The results of all tests are correlated in table 2.

TABLE 2
Properties of the compounds according to table 2

| | | Reference | | | |
|---|---|---|---|---|---|
| | | example A | Example 1 | Example 2 | Example 3 |
| Hardness | Shore A | 81 | 84 | 80 | 78 |
| Density | g/cm³ | 1.487 | 1.499 | 1.464 | 1.504 |
| Ultimate | MPa | 3.05 | 4.02 | 4.64 | 4.42 |
| stress | | | | | |
| Strain at | % | 377 | 527 | 492 | 560 |
| break | | | | | |
| VOC value | μg/g | 86 | 164 | 96 | 41 |
| (VDA 278) | | | | | |
| FOG value | μg/g | 1495 | 828 | 78 | 78 |
| (VDA 278) | | | | | |

The polymer compositions according to the invention surprisingly have a distinctly longer strain at break and at the same time a distinctly higher ultimate stress. The strain at break of a TPE-S measured according to DIN 53504 is preferably in the range of >400%, especially preferably in the range between 450 and 700% and therefore distinctly above the strain at break of polymer compositions with plastics based on mineral oil. The ultimate stress of a TPE-S measured according to DIN 5504 is preferably >3.5 MPa, especially preferably between 4.00 and 5.00. Even the ultimate stress is accordingly better than in polymer compositions with mineral-oil-based plastics.

The compounds according to the invention have, in comparison to compounds with traditional plasticizers based on mineral oil, good mechanical properties, a distinctly better strain at break and ultimate stress and low VOC values and FOG values.

Furthermore, different plasticizers were worked into an EPDM. The formulations of the produced EPDM's are shown in table 3a. All raw materials were used without other pretreatment.

TABLE 3a
Formulations of the EPDE compounds produced
(parts by weight)

| | Reference | Ex- | Ex- |
|---|---|---|---|
| Material | example B | ample 4 | ample 5 |
| EPDM (Keltan 5470 C from the | 100 | 100 | 100 |
| LANXESS Deutschland GmbH company | | | |
| Carbon black (N550 from the Birla | 120 | 120 | 120 |
| Carbon company) | | | |
| Zink oxide (ZnO RS from the Grillo | 5 | 5 | 5 |
| Zinkoxid GmbH company) | | | |
| Stearic acid (from the NOF Corporation | 1 | 1 | 1 |
| company) | | | |
| Accelerator (Rhenogran MBTS-80 from | 1 | 1 | 1 |
| the Rhein Chemie Additives company) | | | |
| Accelerator (Rhenogran TBzTD-70 from | 3 | 3 | 3 |
| the Rhein Chemie Additives company) | | | |
| Sulphur (Rhenogran S-80 from the Rhein | 1 | 1 | 1 |
| Chemie Additives company) | | | |
| Paraffinic plasticizer based on mineral oil | 60 | | |
| (Tudalen 12 from the Hansen & Rosenthal | | | |
| KG company) | | | |
| Octadecanoic acid, 2-ethylhexyl ester | | 65 | |
| (Crodamol OS-LQ from the Croda | | | |
| company) | | | |
| Fatty acids, C18-unsatd., dimers, bis(2- | | | 55 |
| ethylhexyl) esters (Priolub 1875 from the | | | |
| Croda company | | | |

The examined EPDM formulations are shown in table 3a. The compounds were mixed in a closed mixer according to the mixing process according to table 3b. The hardeners (accelerator and sulfur) were added in a double-roller mill at 50° C. The resulting formulations were vulcanized in a Rheometer Optimum at 170° C. in order to obtain the corresponding EPDM compounds.

TABLE 3b
Mixing steps for carbon black compounds

First step: closed mixer 50° C., 50 rpm^{a)}

| | |
|---|---|
| Mixing sequence: | 0.0 min rubber |
| | 2.0 min ½ carbon black + ½ oil^{b)} + zinc oxide + |
| | stearic acid |
| | 4.0 min ½ carbon black + ½ oil^{b)} |
| | 7.0 min sweep |
| | 10.0 min dump |

second step (after 24 h at 23° C.): open roller, 20° C., 10/10 rpm^{a)}
Mixing sequence: 0.0 min vulcanizing agent and accelerator
6.0 min cross blend and sheet off
^{a)}rpm - (rotations per minute) rotations per minute
^{b)}paraffinic plasticizer based on mineral oil, octadecanoic acid (stearic acid), 2-ethyl hexyl ester or fatty acid, C 18-unsat. Dimers, bis(2-ethyl hexyl) ester

### Testing Methods

### 1. Vulcanization Behavior

The vulcanization behavior, e.g., the hardening times T50, T90 and the parameter “Fmin-Fmax [dNm]” were determined at 170° C. according to DIN 53529 (part 3) using an Alpha Technologies Rheometer MDR 2000.2.

### 2. Mooney Viscosity

The Mooney viscosity, e.g., the parameters “I-value [MU]” and “ML (1+4) [MU]”) were determined according to DIN 53523/3 at 100° C. using a rubber testing device (Rubber Process Analyzer) MV 2000.

### 3. Hardness

The hardness (Shore A) was determined before and after aging of the samples in air for 72 h at 100° C. according to DIN ISO 7619-1 using a Zwick 3114/5 device (Shore A).

### 4. Mechanical Properties

The mechanical properties (strain at break, ultimate stress and 100% modulus) were measured according to DIN 53504 (using a Zwick testing device, Zwick/Roell material testing machine BT1-FR 005THA50). The rebound elasticity was determined according to DIN 53512 (using Zwick 5109). The tensile strength was determined according to DIN 34-1:2004.

### 5. Compression Molding (DVR)

The compression molding was measured according to DIN ISO 815. The tests were carried out at different temperatures.

### 6. Evaporation Loss

The rubber mixtures were stored for 7 days at 130° C. The samples were weighed before and after. The evaporation loss is calculated in percent by mass.

The results of all tests are collated in table 4.

TABLE 4
Properties of the polymer compositions according to table 3

| Property | Unit | Example B | Example 4 | Example 5 |
|---|---|---|---|---|
| Mooney viscosity, | MU | 71 | 86 | 68 |
| 100° C. (ML 1 + 4) | | | | |
| Mooney scorch at | MU | | | |
| 130° C. | | | | |
| T5 | min | 13 | 12 | 13 |
| T35 | min | 19 | 18 | 20 |
| Rheometer 2000, 170° C. | | | | |
| Fmin | dNm | 1.9 | 2.6 | 1.9 |
| Fmax | dNm | 15.4 | 15.6 | 13.9 |
| Fmax − Fmin | dNm | 13.5 | 13.0 | 12.0 |
| ts2 | min | 3.4 | 3.2 | 3.3 |
| t10 | min | 3.1 | 2.9 | 3.0 |
| t50 | min | 5.3 | 5.0 | 5.0 |
| t90 | min | 10.5 | 9.8 | 8.9 |
| t90 − t10 | min | 7.4 | 6.9 | 5.9 |
| Vulcanization t90 × | | | | |
| 1.5 at 170° C. | | | | |
| Hardness | Shore A | 75 | 78 | 76 |
| Expansion | % | 360 | 270 | 340 |
| Tensile strength | MPa | 16 | 15 | 16 |
| Modulus 100 | MPa | 6 | 6 | 6 |
| DVR 22 h 4° C. | % | 5 | 4 | 6 |
| DVR 22 h 100° C. | % | 1 | 12 | 14 |
| DVR 22 h 125° C. | % | 50 | 45 | 52 |
| Ageing 72 h at 100° C. | | | | |
| Hardness | Shore A | 77 | 80 | 78 |
| Hardness change | % | 3 | 3 | 3 |
| Expansion | % | 280 | 260 | 310 |
| Expansion change | % | −22 | −4 | −9 |
| Tensile strength | MPa | 16 | 16 | 17 |
| Tensile strength | % | −3 | 10 | Seven |
| change | | | | |
| Modulus 100 | MPa | 7 | 7 | 7 |
| Tensile strength | % | 18 | 16 | 25 |
| change | | | | |
| Loss oil - storage 7 | % | 11 | 8 | 3 |
| days at 130° C. | | | | |

the following properties were improved:
It can be very clearly recognized that the plasticizers in the polymer compositions according to the invention result in a rapid but manageable vulcanizing time (t90-t10), which makes it possible to lower the cost during the manufacture of rubber articles.
The aging properties of the EPDM compounds were improved with the plasticizers according to the invention (see changes in expansion and tensile strength). As a result, the service life of the technical plastic products according to the present invention is increased.
The oil loss after a storage at 130° C. for 7 days is dramatically lower. The lesser the evaporation loss of an oil, the more stable its viscosity properties, its physical properties and its hardness after a rather long storage time.
The pressure deformations tests in the case of example 4 show that the values at 4° C. and 100° C. are comparable to the values of reference example B. The value for 125° C. is distinctly lower than in reference example B. The lower the value, the better the material resists permanent the formation under a defined deflection and temperature.

1-14. (canceled)

15. A polymer composition containing
a) a thermoplastic elastomer, a rubber or a bioplastic and
b) a plasticizer,
wherein the plasticizer is a vegetable raw material or a raw material product based on an industrial plant or on the basis of an animal fat source.

16. The polymer composition according to claim 15, wherein the vegetable raw material is a mixture of different organic compounds which is obtained by extraction or pressing from a plant.

17. The polymer composition according to claim 15, wherein the industrial plant is selected from the group consisting of trees, sunflower, rape, beets, corn, linseed oil, jojoba, peanut, coconut, thistle, castor oil, soybean, palm, hemp, poppy, olive, sugarcane, sugar beet and grain, and that the animal fat source is selected from the group consisting of butter, lard, tallow, fat, herring and sardine.

18. The polymer composition according to claim 15, wherein the vegetable raw material is a vegetable oil selected from the group consisting of lignin oil, sunflower oil, rape oil, beet oil, corn oil, hemp oil, olive oil, linseed oil, soybean oil, palm oil, and poppy oil, or the vegetable raw material is a raw material product derived from starch, cellulose or lignin.

19. The polymer composition according to claim 17, wherein the vegetable raw material is derived from sugarcane or sugar beet, palm oil, sunflowers or rape.

20. The polymer composition according to claim 15, wherein the plasticizer from the vegetable raw material is selected from the groups I to III with
I) group I fatty esters according to formula (I)
II) group II triglycerides according to formula (II) and
III) group III dimerates according to formula (III),
wherein the plasticizers of group I are fatty acids esters according to the formula (1) 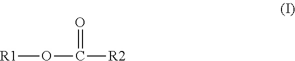
wherein
R1 is a substituted or unsubstituted aryl group with 1 to 22 carbon atoms, or a substituted or unsubstituted, linear or branched alkyl group with 1 to 22 carbon atoms, or a substituted or unsubstituted, linear or branched alkene group with 1 to 22 carbon atoms and one, two or three double bonds, and
R2 is a substituted or unsubstituted linear or branched, saturated or unsaturated aliphatic hydrocarbon group with 1 to 21 carbon atoms, or
wherein the plasticizers of group II are triglycerides according to formula (II) 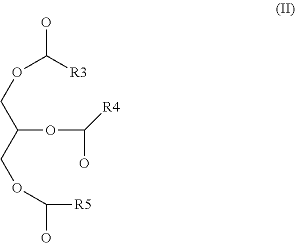
wherein R3, R4 and R5 are a substituted or unsubstituted, linear or branched alkyl group with 1 to 22 carbon atoms or a substituted or unsubstituted, linear or branched alkene group with 1 to 22 carbon atoms and one, two or three double bonds, or
wherein the plasticizers of the group III are dimerates in the form of a reaction product of a dimeric acid according to the formula (III) and of a straight-chain or branched alcohol which is saturated or unsaturated with 1 to 3 carbon-carbon double bonds and has 1 to 22 carbon atoms: 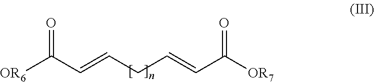
wherein n is a whole number between 1 and 40, and R6 and R7 are independently of one another each a substituted or unsubstituted, linear or branched alkyl group with 1 to 22 carbon atoms.

21. The polymer composition according to claim 20, wherein the R2 is a linear, unsaturated, aliphatic hydrocarbon group with 1 to 21 carbon atoms and one, two or three double bonds.

22. The polymer composition according to claim 20, wherein the R6 and R7 are independently of one another each a substituted or unsubstituted, linear or branched alkyl group with 1 to 22 carbon atoms selected from the group consisting of methyl-, ethyl-, propyl-, butyl-, pentyl-, hexyl-, heptyl-, octyl-, 2-ethyl-hexyl, nonyl-, decyl-, stearyl- and oleyl-groups.

23. The polymer composition according to claim 15, wherein the thermoplastic elastomer is a styrene block copolymer (TPE-S).

24. The polymer composition according to claim 23, wherein the styrene block copolymer (TPE-S) is selected from the group consisting of a styrene-butylene-styrene block polymer (SBS), styrene-butylene-styrene (SBS), and a styrene-ethylene/butylene-styrene block polymer (SEBS).

25. The polymer composition according to claim 15, wherein the rubber is an ethylene-propylene-diene rubber (EPDM).

26. The polymer composition according to claim 25, wherein the ethylene-propylene-diene rubber (EPDM) is an EPDM with 5-ethylidene-2-norbornene as monomer.

27. The polymer composition according to claim 15, wherein the plasticizer is contained in the polymer composition at 1 to 250 parts by weight, preferably 5 to 100 parts by weight, especially preferably 5 to 30 parts by weight relative to the total weight of the polymer composition.

28. The polymer composition according to claim 27, wherein the plasticizer is contained in the polymer composition at 5 to 100 parts by weight.

29. The polymer composition according to claim 27, wherein the plasticizer is contained in the polymer composition at 5 to 30 parts by weight.

30. The polymer composition according to claim 15, wherein the polymer composition has a hardness (Shore A) of 20 to 100 measured according to DIN EN ISO 868.

31. The polymer composition according to claim 30, wherein the polymer composition has a hardness (Shore A) of 30 to 90.

32. The polymer composition according to claim 30, wherein the polymer composition has a hardness (Shore A) of 75 to 85.

33. The polymer composition according to claim 15, wherein the polymer composition has a target VOC value of <100 μg/g measured according to VDA 278.

34. The polymer composition according to claim 15, wherein the polymer composition has a FOG value of <250 μg/g measured according to VDA 278.

35. The polymer composition according to claim 15, wherein the composition contains no plasticizers based on fossil raw materials.

36. A technical plastic item containing a polymer composition of according to claim 15.

37. The technical plastic item according to claim 36, which is a technical rubber item or a technical plastic product.
